(19) United States
(12) Patent Application Publication
(10) Pub. No.: US 2026/0057064 A1
(43) Pub. Date: Feb. 26, 2026

(54) SECURITY ENHANCEMENT FOR INDIRECT PREFETCHER

(71) Applicant: Ampere Computing LLC, Santa Clara, CA (US)

(72) Inventors: Abanti BASAK, San Jose, CA (US); Benjamin Crawford CHAFFIN, Portland, OR (US); Mahesh MADHAV, Portland, OR (US); Eric SCHWARTZ, Portland, OR (US); David TURLEY, Portland, OR (US)

(21) Appl. No.: 18/812,912

(22) Filed: Aug. 22, 2024

(51) Int. Cl. G06F 21/54; G06F 21/55

(52) U.S. Cl. CPC G06F 21/54; G06F 21/552

(57) ABSTRACT

Disclosed is a prefetcher, e.g., of a system with one or more cores. The prefetcher determines data dependency access (DDA) patterns, such as array indirect access, and prefetches data based on the DDA patterns. The training for the DDA patterns may take place upon an occurrence of a prefetch training reset event. The prefetch training reset event may be an execution level change or a context switch.

### BACKGROUND OF THE DISCLOSURE

### 1. Field of the Disclosure

Aspects of the disclosure relate generally to processes associated with prefetching. More specifically, but not exclusively, to security enhancement for an indirect prefetcher.

### 2. Description of the Related Art

Various hardware and software prefetching techniques may be used for speeding up fetch operations by beginning a fetch operation whose result is expected to be needed soon. Software prefetching requires programmer or compiler intervention, whereas hardware prefetching requires special hardware mechanisms. Usually, the fetch operation occurs before the corresponding data is known to be needed, so there is a risk of wasting time and resources by prefetching data that will not be used. For example, prefetching may be used by a processing core to boost execution performance by fetching instructions or data from their original storage in slower memory locations to a faster local cache memory location before the instructions or data is needed. The processing core may have relatively fast and local cache memory in which the prefetched instructions or data is held until it is to be used for processing operations.

The memory source for the prefetch operation is usually main or system-level memory but may also be a higher-level cache memory. Accessing lower-level cache memories is typically faster than accessing main or system-level memory as well as higher level cache memory. Thus, accurate prefetching of instructions or data into lower-level cache(s) from higher-level memories and then accessing it from lower-level caches when the instructions or data are needed may improve system performance.

Some cloud workloads exhibit irregular, array-indirect accesses, making them memory-latency bound (e.g., graph, hash tables). The instructions per cycle (IPC) of these workloads can be significantly improved by accurately prefetching these long-latency accesses. Unfortunately, the irregular, array-indirect access pattern is not well-captured by existing prefetchers. Also, maintaining security of prefetchers is an issue.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

An example of a prefetcher is disclosed. The prefetcher may comprise a training logic configured to determine whether prefetch training information will be used when a prefetch training reset event occurs. The prefetch training reset event may be an execution level (EL) change from a previous execution level to a current execution level, or a context switch from a previous context to a current context within an execution level. The prefetcher may also comprise a stride prefetcher configured to identify a plurality of program counters (PC) of a workload when it is determined that the prefetch training information will be used. The training logic may also be configured to train on data dependent access (DDA) patterns associated with a current execution level, or a current context, or both for one or more prefetch address predictions when it is determined that the prefetch training information will be used. The training logic may comprise an address data table (ADT) configured to store memory access information corresponding to two or more PCs of the plurality of PCs. The ADT may also be configured to identify a producer-consumer pair among the two or more PCs based on the memory access information of the two or more PCs. The producer-consumer pair may comprise a producer PC and a consumer PC of a data dependent access (DDA). The training logic may also comprise a relationship table (RT) configured to store the producer-consumer pair and a prefetch confidence associated with the producer-consumer pair.

An example method of prefetching is disclosed. The method may comprise determining whether prefetch training information will be used when a prefetch training reset event occurs. The prefetch training reset event may be an execution level (EL) change from a previous execution level to a current execution level, or a context switch from a previous context to a current context within an execution level. The method may also include identifying a plurality of program counters (PC) of a workload. The method may further comprise training on data dependent access (DDA) patterns associated with a current execution level, or a current context, or both for one or more prefetch address predictions. The training on the DDA patterns may comprise storing memory access information corresponding to two or more PCs of the plurality of PCs in an address data table (ADT). The training on the DDA patterns may also comprise identifying a producer-consumer pair among the two or more PCs based on the memory access information of the two or more PCs. The producer-consumer pair may comprise a producer PC and a consumer PC of a data dependent access (DDA). The training on the DDA patterns may further comprise storing the producer-consumer pair and a prefetch confidence associated with the producer-consumer pair in a relationship table.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 illustrates an example of a processing unit, according to aspects of the disclosure.

FIG. 2 illustrates an example of a domain-specific prefetcher hardware structure for prefetching virtual addresses, according to aspects of the disclosure.

FIGS. 3 and 4 are flow charts of an example method for data dependent access of a prefetcher, according to aspects of the disclosure.

FIG. 5 is a flow chart of an example method for prefetching that incorporates security enhancement when training for data dependent access prefetch address prediction.

### DETAILED DESCRIPTION

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

Various aspects of the subject technology relate to hardware structures and techniques training and performing data dependent access (DDA) prefetches in a secure fashion. For example, when there is an execution level change and/or a context switch, the training may be restarted from an initial state.

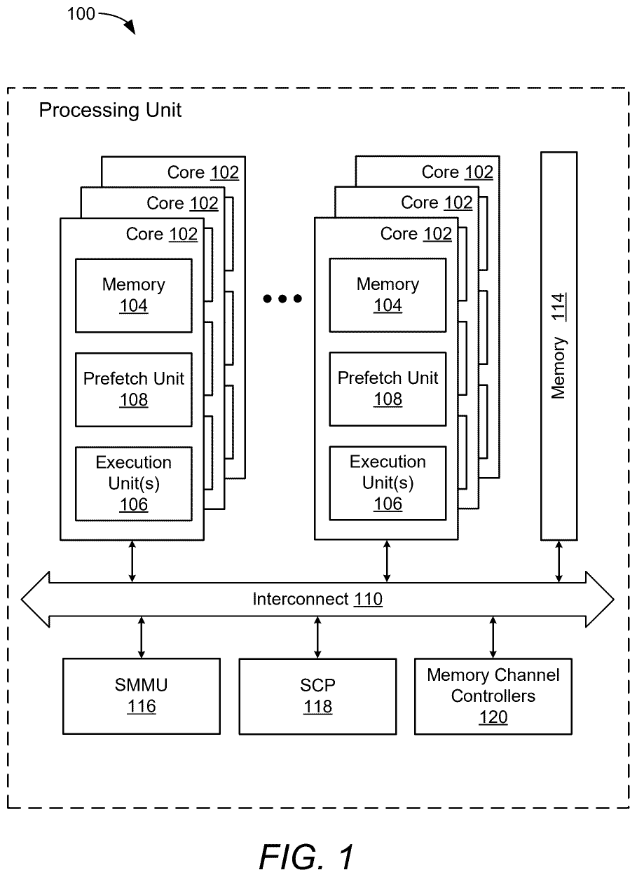

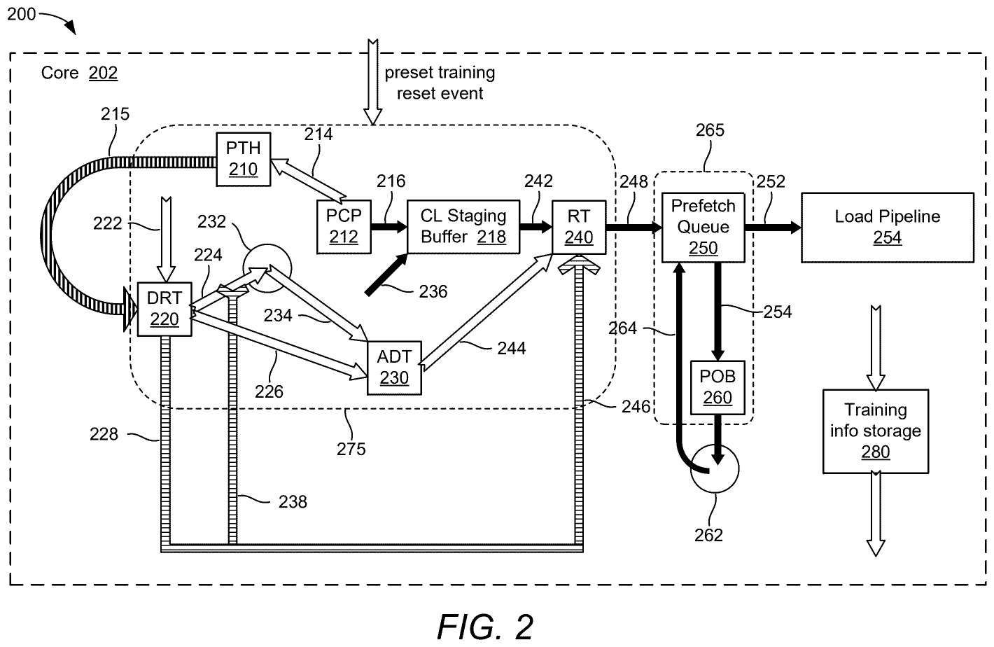

FIG. 1 illustrates a first example of a processing unit 100, according to aspects of the disclosure. In one or more aspects, the hardware structures and techniques for replaying virtual addresses described herein may be implemented using processing unit 100. Processing unit 100 may be configured as a central processing unit (CPU) but may also be used with or configured as other processing units, such as but not limited to a graphics processing (GPU) or tensor processing unit (TPU). Processing unit 100 may include a set of processing cores 102 (or simply “cores” 102). Each core 102 may include memory 104, one or more execution units 106, and prefetch unit 108. Each core 102 may be coupled to interconnect 110, which may be a system on chip (SoC) coherent interconnect. In one or more aspects, memory 104 may be configured as cache on the core 102 (e.g., 16 KB or 64 kB L1 Instruction-cache, 64 KB L1 Data-cache, and 1 MB or 2 MB level 2 (L2) Cache, in some aspects). Details of an example core 102 are further described below with respect to FIG. 2 in relation to a prefetcher.

The one or more execution units 106 may perform various operations and calculations associated with instructions and micro-operations of the core 102. The one or more execution units 106 may be configured as various units in the core 102 in accordance with various implementations. For example, the one or more execution units 106 may include arithmetic logic units (ALUs) that perform arithmetic and logic operations for the core 102. The one or more execution units 106 may include floating point units (FPUs) that perform floating point calculations. The one or more execution units 106 may include integer execution units (IXUs) for performing integer operations. The one or more execution units 106 may also include single instruction, multiple data (SIMD) execution units for performing various instructions. In one or more aspects, an execution unit 106 may perform a combination of these and other operations. Each of the one or more execution units 106 may include a bus or interconnect, for example, to connect hardware elements of the execution units 106 to memory 104 to perform read and write functions while executing micro-operations. Alternatively, or in addition thereto, one or more execution units 106 including ALUs, FPUs, IXUs, and/or SIMD execution units may be configured for all or a subset of the cores 102.

The prefetch unit 108 may include various hardware structures within the core 102. In one or more aspects, the prefetch unit 108 may be configured to prefetch data and/or instructions associated with operations of the core 102 in accordance with various implementations. For example, the prefetch unit 108 may perform fetch operations from various memory locations before the corresponding data and/or instructions are known to be needed by the execution units 106 and places the data and/or instructions into a particular cache of the memory 104 in the core 102. Various aspects and implementations of the prefetch unit 108 are described herein, for example, with respect to FIGS. 2-4.

Processing unit 100 may also include memory 114, which may be coupled to interconnect 110. In one or more aspects, memory 114 may include system memory, system-level cache (e.g., 32 MB or 64 MB, in some aspects) that may be used for various purposes by the processing unit 100, or other levels of cache and system memory. Processing unit 100 may also include a system memory management unit (SMMU) 116, The SMMU 116 may provide translation services, for example, to non-processor initiator units. For example, the SMMU 116 may translate addresses for direct memory address (DMA) requests from system input/output (I/O) devices before the requests are passed to interconnect 110. Processing unit 100 may also include a system control processor (SCP) 118. The SCP 118 may be configured to handle various system management functions. In one or more aspects, the SCP 118 may include separate microcontrollers (or processors). In one or more aspects, the SCP 118 may be combined into one or two microcontrollers, or sub-divided into more than two microcontrollers in accordance with various implementations to handle various system management functions.

Interconnect 110 may be configured as a mesh interconnect that forms a high-speed interface that couples each core 102 to the other cores 102 and other components in processing unit 100. Processing unit 100 may also include memory channel controllers 120 that may be operatively coupled to various memory devices (e.g., external to the processing unit 100). For example, the memory channel controllers 120 may be configured for accessing memory, such as a double data rate (DDR) synchronous dynamic random-access memory (SDRAM) or other memory sources.

It is to be appreciated that the processing unit 100 of FIG. 1 may be configured according to a monolithic die design or a disaggregated chiplet design. For example, in the monolithic die design, the cores 102, interconnect 110, memory 114, SMMU 116, and SCP 118 may be configured on a single die. In some cases, for example, in the disaggregated chiplet design, each chiplet of multiple disaggregated chiplets may include a subset of the cores 102 (e.g., in a tiled fashion) with a memory controller to control a portion of memory 114, and a peripheral component interconnect (PCI) or PCI express (PCIe) controller to control the interface with interconnect 110, SMMU 116, and/or SCP 118. Alternatively, or in addition thereto, other computer architecture designs may be used in various implementations given the benefit of the disclosure.

FIG. 2 illustrates an example of a domain-specific prefetcher hardware structure 200 for prefetching virtual addresses, according to aspects of the disclosure. The domain-specific prefetcher hardware structure 200, which may also be referred to as a prefetcher 200, may be configured to observe load and store access patterns and prefetch data based on the past access behavior corresponding to these observed patterns. In some cases, an entirety of the prefetcher 200 may be implemented in hardware. In one or more aspects, the prefetcher 200 may be included in a processing core 202, e.g., of a system-on-chip (SoC). In one or more aspects, the prefetcher 200 may map to the prefetch unit 108 of FIG. 1. In one or more aspects, the prefetcher 200 may be one of K prefetchers (e.g., one or K prefetch units 108) of the SoC, K≥1. The core (e.g., core 102, 202) may be one of L cores of the SoC, L≥1. If K=L, then there may be a one-to-one correspondence (i.e., a prefetcher 200 prefetching for a core 202). Alternatively, there may be a one-to-many correspondence (i.e., a prefetcher 200 prefetching for multiple cores 202). In another alternative, there may be a many-to-one correspondence (i.e., multiple prefetchers 200 prefetching for a core 202).

As indicated above, in some scenarios, cloud native workloads running on a processing unit may exhibit irregular, array-indirect accesses. These irregular, array-indirect accesses may cause the cloud native workloads to be memory-latency bound (e.g., graph, hash tables, etc.). In some cases, the instruction per cycle (IPC) of these cloud native workloads can be significantly improved by accurately prefetching these irregular, array-indirect accesses that would otherwise result in long-latency accesses. Various array-indirect access patterns are not well-captured by existing prefetcher architectures.

Accordingly, aspects of the disclosure address the need to incorporate a HW prefetcher architecture capable of (1) identifying array-indirect relationship patterns with high success rate and (2) accurately and securely prefetching for these irregular, array-indirect accesses. Alternatively, or in addition thereto, because cloud servers typically run diverse workloads comprising both array-indirect accesses and other access types without array-indirect characteristics, the prefetcher 200 may be designed such that an excessive power tax is avoided when processing these other access types. For example, some unnecessary or inaccurate prefetch operations may be performed by a prefetcher when a processing core is running workloads without any array-indirect accesses. As such, unnecessary or inaccurate prefetch operations are minimized by various design aspects of the prefetcher 200 so that the power tax on the processing core 202 is minimized.

Array-indirect hardware prefetchers are designed to improve the performance of data-dependent memory accesses (DDAs) across graph analytics (GA) frameworks. Certain array-indirect hardware prefetcher architectures may be inadequate for prefetching array-indirect accesses in cloud servers that handle cloud native workloads. First, the out-of-order training in a typical array-indirect hardware prefetcher architecture may not be sufficiently accurate to provide an acceptable success rate for prefetch training for cloud servers. Second, a typical array-indirect hardware prefetcher architecture is focused on GA workloads and does not consider or address the power tax issue for non-GA workloads.

Because cloud servers generally run heterogeneous workloads that may or may not exhibit array-indirect accesses, aspects of the disclosure relate to ensuring that the power tax for the workloads with other access types that do not exhibit array-indirect accesses is as low as possible. It is to be noted that a typical array-indirect hardware prefetcher architecture's out-of-order training makes it difficult to optimize power. Further, a typical array-indirect hardware prefetcher architecture typically does not consider ensuring the security of the prefetcher, which may be critical for some cloud customers (e.g., certain integrated chip designs with data-dependent prefetchers have been compromised in the past). For example, certain prefetchers may prefetch data from an address that is out of bounds of the array being predicted as a next processing core request. Thus, a prefetcher may prefetch this data before the prefetcher realizes (e.g., through subsequent failed validations) that the program does not intend to access beyond the array bounds. For example, an indirection-based data memory-dependent prefetcher that prefetches certain patterns can be exploited to cause a leak all of program memory in some scenarios.

At least for these reasons, the prefetcher 200 described herein differs from a typical array-indirect hardware prefetcher architecture. In some aspects, the prefetcher 200 is an accurate, secure, and power-optimized prefetcher design desirable for processing units configured for cloud servers.

In accordance with some aspects, the training and confidence measurement in the prefetcher 200 may occur at the commit stage to ensure a high success rate of finding array-indirect relationships. In contrast, a typical array-indirect hardware prefetcher architecture trains at the cache-access time, which may be vulnerable to out-of-orderness. This out-of-orderness characteristic in a typical array-indirect hardware prefetcher architecture makes it difficult to find correct relationships with high success rate.

Also, to maintain security of prefetchers, it is proposed to reset the training of the prefetcher when a prefetch training reset event occurs. When the prefetcher is training on the data dependent access (DDA) patterns for one or more prefetch address predictions, the training may be associated with a current execution level, or a current context, or both of a core, such as core 102, 202. In particular, the execution level and/or the context may be associated with the execution unit 106 of the core. For security purposes, for some execution levels and/or for some contexts, the prefetcher training based on the DDA patterns may be selectively enabled or disabled. Before discussing the security measures, details regarding the prefetcher training itself will be discussed.

Performing the training and confidence measurement at the commit stage enables throttling training and confidence measurement for power while minimizing any negative impact on performance. Alternatively, or in addition thereto, performing the training and confidence measurement at the commit stage enables gating for security while minimizing any impact on performance upon entering a new context. In this manner, new array-indirect and/or other data-dependent relationships may be determined quickly.

In the example of FIG. 2, a program counter (PC) transition history (PTH) 210 and data retrieval table (DRT) 220 may be configured to enable training at commit time. The PTH 210 may be configured to store a plurality of PCs identified by a (PCP) stride prefetcher 212 as having stride accesses at or above a minimum stride confidence threshold. That is, the stride prefetcher 212 may be configured to identify a plurality of program counters (PC) of a workload. The identified PCs may be PCs whose stride accesses are at or above the minimum stride confidence threshold. For example, a stride of a PC may be predicted. However, there may also be a determination of a level of confidence on whether the predicted stride will actually occur. The stride prefetcher 212 may determine the stride confidences associated with the PCs and identify those PCs whose stride confidences meet the minimum stride confidence threshold.

In one or more aspects, the PTH 210 may be an M-entry first-in-first-out (FIFO) buffer, where M≥2 (e.g., 4). The PTH 210 may record the PCs exhibiting high-confidence stride accesses (e.g., those that meet or exceed the minimum stride confidence threshold) in a precision, coverage, and the stride prefetcher 212. The plurality of PCs stored in the PTH 210 may include the two or more PCs whose memory access information is stored in an access data table (ADT) 230. A typical array-indirect hardware prefetcher architecture training considers these PCs potentially likely to establish an array-indirect relationship.

The ADT 230 may be configured to store memory access information corresponding to two or more PCs of the plurality of PCs. In an aspect, for each PC, the memory access information may comprise, among others, a PC identifier, a first address, a first data, a second address, and a second data. For a PC in the ADT 230, the PC identifier may be an identifier of the PC, the first address may be an address of a first load instruction of the PC, the first data may be a data corresponding to the first load instruction of the PC, the second address may be an address of a second load instruction of the PC subsequent to the first load instruction of the PC, and the second data may be a data corresponding to the second load instruction of the PC. Also, for the PC in the ADT 230, the first address and first data may be related to address and data of the PC when the first load instruction is committed and the second address and second data may be related to address and data of the PC when the second load instruction is committed. The first and second addresses may be virtual addresses.

The ADT 230 may also be configured to identify a producer-consumer pair among the two or more PCs stored therein based on the memory access information of the two or more PCs. The producer-consumer pair may comprise a producer PC and a consumer PC of a data dependent access (DDA), e.g., array indirect access or a pointer based access.

Before going further, the concept of producer and consumer is briefly explained. Consider a simple data-dependent problem as in a following loop of code:
for (i=0, i<3, i++)
   node=B[i];
   color=A[node];
end

In the code loop, the component “A [node]” can also be equivalent to “A[B[i]]”. In this instance, the array B is the producer. This is because its data is used to “produce” an index to access the second array A. Here, array A is the consumer.

The DRT 220 may be configured to store data of one or more load instructions that have not yet been committed. That is, the DRT 220 may be configured to store the data of certain loads until they have committed, thus making the data available at commit for array-indirect training and confidence measurement. In one or more aspects, the DRT 220 may be an N-entry table, where N≥2 (e.g., 8). Note that in some aspects, the DRT 220 may be separate from any cache or memory such that the DRT 220 is not visible to any core, such as the cores 102.

The DRT 220 may be indexed with a load order buffer identifier (LOBID) (e.g., LOBID[2:0], 3 bits in case N=8) of load instructions. In some cases, a new entry may be allocated to the DRT 220 at an issuance of a load instruction if (1) the PC of the load instruction exists in the PTH 210; (2) the PC of the load instruction is also the PC in the first entry of the ADT 230; and/or (3) the PC of the load instruction is building a prefetch confidence (discussed in more detail below) in a relationship table (RT) 240. For example, when the data of an allocated entry of the DRT 220 is available, the data field of the DRT entry may be populated. In one or more aspects, when a load corresponding to an allocated entry of the DRT 220 is committed, the entry may be freed once the data has been consumed for training. The RT 240 may be configured to store the producer-consumer pair (e.g., identified by the ADT 230) and a prefetch confidence associated with the producer-consumer pair.

In addition to the PTH 210, DRT 220, ADT 230, and RT 240, the prefetcher 200 may also include a prefetch queue 250, a prefetch outstanding buffer (POB) 260, and additional hardware structures. As illustrated in FIG. 2, additional hardware blocks, traces, and operations may be included in the prefetcher 200.

For conciseness, the prefetch queue 250 and the POB 260 may together be referred to as “prefetch logic” 265. In an aspect, the prefetch logic 265 may be configured to prefetch one or more data for a producer-consumer pair when the prefetch confidence of the producer-consumer pair is at or above a minimum prefetch confidence threshold (different from the minimum stride confidence threshold). The one or more data may be prefetched into a level one (L1) cache. There can be any number of producer-consumer pairs among the PCs stored in the ADT 230. Each producer-consumer pair may comprise a producer PC and a consumer PC of a data dependent access (DDA).

In accordance with some aspects, at operation 215, the PTH 210 may allocate LOBIDs and data of loads that belong to the PCs in the PTH 210. For example, when a load executes, information associated with the executed load (e.g., PC, virtual address, valid bits, data, etc.) may be kept in a storage buffer, such as a load ordering buffer (LOB) until the load can be retired. The LOB may have several entries that are indexed by a pointer called the LOBID.

In one or more aspects, the DRT 220 may allocate entries therein using the LOBID. In this manner, when loads are being tracked by the prefetcher 200 to obtain data, the data can be written into the DRT 220 as well (e.g., along with the PC and virtual address of the executed load) for later use. For example, the DRT 220 may be provided the data of a potential producer PC that is available at the commit stage. Operation 215 may assist the training phase to obtain data at commit time. Some arrows in the prefetcher 200 may correspond to training traces or phase: first training trace 214, second training trace 222, third training trace 224, fourth training trace 226, fifth training trace 234, and sixth training trace 244. In an aspect, various combinations of the components involved with the training phase—the PTH 210, the PCP stride fetcher 212, the DRT 220, the ADT 230, and the RT 240—may be referred to as the training logic 275.

The first training trace 214 may be between the PCP stride prefetcher 212 and the PTH 210. The PCP stride prefetcher 212 may provide a PC with a state change (e.g., ACT_HI→ACT_LO or ACT_LO→ACT_HI) to the PTH 210 via the first training trace 214. The PTH 210 may use the PCs received from the PCP stride prefetcher 212 for operation 215 discussed above.

The second training trace 222 may provide a load commit PC (e.g., PC [<X>] virtual address [<0x0002a>]) to the DRT 220. The DRT 220 may act on the load commit PC depending on whether the data entry (e.g., 8 bytes of data) for the load commit PC is included in the DRT 220 or whether the load commit PC is already triggered in the ADT 230. For example, if the data entry for the load commit PC is not included in the DRT 220, then the third training trace 224 may be selected (e.g., ‘no’ branch). If data entry for the load commit PC is included in the DRT 220, then the fourth training trace 226 may be selected (e.g., ‘yes’ branch).

In one or more aspects, when the third training trace 224 is selected (e.g., data entry for the load commit PC is not included-‘no’ branch), a decision operation 232 may be made whether the ADT 230 is already triggered for the load commit PC such that the PC is a potential consumer to be matched with an entry having the same PC in the ADT 230. If the ADT 230 is already triggered for the load commit PC, then the fifth training trace 234 may operate to send the virtual address of the potential consumer PC and the data of the potential consumer PC to the ADT 230 for population in the ADT 230. If the ADT 230 is not already triggered for the PC of the potential consumer, then the decision operation 232 of the prefetcher 200 may operate to drop the load commit PC.

In one or more aspects, when the fourth training trace 226 is selected (e.g., data entry for the load commit PC is included—‘yes’ branch), the ADT 230 may be triggered with the PC of the potential producer-consumer pair. That is for example, the fourth training trace 226 may operate to send the virtual address and the data of the potential producer/consumer PC stored in the DRT 220 to the ADT 230 for population as an entry in the ADT 230.

In one or more aspects, the ADT 230 may perform training on the entries of the ADT 230 that have been populated by the DRT 220 to identify DDAs, such as array-indirect accesses and pointer-based accesses between PCs. The sixth training trace 244 may operate to send these identified DDAs to the RT 240. For example, the serialized division in the entries of the ADT 230 may identify PC tuples or producer-consumer pairs, and these PC tuples (e.g., [<C,D>]) may be sent to the RT 240.

Referring back to the producer/consumer code above, when the producer array (e.g., array B above) is stepped through, it can be done with a strided access. The PCP stride prefetcher 212 may be able to identify PC's that exhibit this behavior and identify them as potential producers. Once a potential producer is identified, its next execution may “trigger” the ADT 230 to begin storing information for both the potential producers as well as the potential consumers. Once two or more passes of producer data and consumer addresses are stored, that information can be used to determine if any producer/consumer relationships can be found. The data that is stored in the ADT 230 for the potential producer may be data that was read from the DRT 220. This is because the population of the ADT 230 occurs at commit time, which is after the data is written to the DRT 220.

In general, when a load instruction is committed, the training logic 275, or more generally the prefetcher 200, may be configured to determine whether there is data corresponding to the committed load instruction in the DRT 220 based on a commit PC and a commit address of the load instruction. When it is determined that there is data corresponding to the load instruction in the DRT 220, the ADT 230 may be triggered with a potential producer's PC's data. When it is determined that there is data corresponding to the load instruction in the DRT 220 and when the ADT 230 is already triggered, the committed load instruction may be provided as a potential producer to the ADT 230 including the PC identifier, the first address, and the first data of the committed load instruction.

It is noted that the training logic need not be operating 100% of the time. Through experimentation, it has been realized that when a data dependent relationship is discovered, that relationship is invariant over a significant portion of the program, and perhaps invariant over the whole program. Thus, even partial training (e.g., 20% duty cycle meaning training 20% of the time the prefetcher 200 is operating) to determine the data dependent relationship would retain most of the benefits. In short, by training only a part of the time, power consumption can be decreased significantly while retaining most of the benefits.

Some arrows in the prefetcher 200 correspond to confidence tracking traces or phase: first confidence tracking trace 228, second confidence tracking trace 238, and third confidence tracking trace 246. The confidence may also be referred to as “prefetch confidence”. In one or more aspects, the first confidence tracking trace 228 may provide a confidence measurement corresponding to the PC of the producer. For example, if (PC [<X>]==a producer PC in the RT 240), then predict the virtual address using possible PC tuples (e.g., [<C,D>], [<B,C>], etc.).

In one or more aspects, the second confidence tracking trace 238 may provide a confidence measurement corresponding to the PC of the consumer. For example, if the load commit PC provided to the DRT 220 via the second training trace 222 is included as a consumer PC in the RT 240 (e.g., PC [<X>]==a consumer PC in the RT 240, etc.) and a predicted virtual address stored in the RT 240 is equals to the virtual address associated with the load commit PC (e.g., stored predicted virtual address==[<0x0002a>], etc.), then a confidence level attributed to the virtual address associated with the load commit PC may be increased (e.g., confidence++, etc.); else the confidence level attributed to the virtual address associated with the load commit PC may be decreased (e.g., confidence—, etc.).

The prefetch confidence determination may be viewed as follows. When a data-dependent relationship (e.g., DDA) is established via training and written to the RT 240, there is a “confidence building” phase that the relationship should pass before generating prefetches. When a load micro-operation (μop) with a PC matching an RT entry's producer PC executes, the producer's data may be used to compute a “predicted address” for the consumer μop that follows. Then, when the consumer μop executes, its virtual address (VA) may be compared with the VA predicted earlier in the RT 240. If they match, confidence increases. If they do not match, confidence decreases. Once the prefetch confidence is at or above a minimum prefetch confidence threshold, the relationship can be used to begin issuing prefetches.

Regarding confidence measurement, the training logic 275 (or more generally the prefetcher 200) may be configured to determine if the commit PC is identified as a producer PC of a producer-consumer pair in the RT 240. When it is determined that the commit PC is identified as the producer PC of the producer-consumer pair, a predicted address may be determined based on base address and offset size of the producer-consumer pair. The predicted address may be stored in the RT 240.

Also regarding confidence measurement, the training logic 275 (or more generally the prefetcher 200) may be configured to determine if the commit PC is identified as a consumer PC of a producer-consumer pair in the RT 240. When it is determined that the commit PC is identified as the consumer PC of the producer-consumer pair, the prefetch confidence of the producer-consumer pair may be increased when a predicted address of the producer-consumer pair matches the commit address. Otherwise, the prefetch confidence of the producer-consumer pair may be decreased when the predicted address of the producer-consumer pair does not match the commit address.

Some arrows in the prefetcher 200 may correspond to prefetch generation traces: first prefetch generation trace 216, second prefetch generation trace 236, third prefetch generation trace 242, fourth prefetch generation trace 248, fifth prefetch generation trace 252, sixth prefetch generation trace 254, and seventh prefetch generation trace 264. The first prefetch generation trace 216 may operate to send PCP stride information from the PCP stride prefetcher 212 to the cache line (CL) staging buffer 218. The second prefetch generation trace 236 may operate to provide a demand fill to the CL staging buffer 218. CL may be staged when it comes back from the memory system, so that the prefetcher may spin through and calculate the prefetch addresses. Note that if the CL is not staged, then the data has to be looked up in the L1 cache, which takes both time and power.

In one or more aspects, the CL staging buffer 218 may perform a CL stepping function. The third prefetch generation trace 242 may operate to provide data from CL stepping of the CL staging buffer 218 to the RT 240. In some implementations, the data from CL stepping of the CL staging buffer 218 may be in multiple bytes. In an implementation, the multiple bytes may be in multiples of 4 bytes (e.g., 4 bytes, 8 bytes, etc.). The RT 240 may include DDAs and confidence in the entries of the RT 240 may be built based on inputs from the third confidence tracking trace 246. The prefetcher 200 may generate prefetch operation when the entries of the RT 240 satisfy a minimum prefetch confidence threshold.

In one or more aspects, the fourth prefetch generation trace 248 may operate to send the virtual address associated with the prefetch operation to the prefetch queue 250. The prefetcher 200 may perform a virtual-to-physical address translation in the prefetch queue 250 with respect to a translation lookaside buffer (TLB). If there is a TLB hit, the fifth prefetch generation trace 252 may operate to send the successful prefetch operation and corresponding address information to the load pipeline for launching the prefetch operation.

The prefetching operation may viewed as follows. When a data-dependent relationship is established, the relationship may comprise two pieces of information: A base address of the consumer array, and an offset that indicates the size of each consumer array element. To generate a predicted address from a producer PC commit, the producer's data from the DRT 220 may be read, and the following equation may be applied:

$$Address A [ B [ i ] ] = A ' s base address + Offset size \times B [ i ]$$

In the above equation, B[i] may be the producer data from the DRT 220. This predicted address of the consumer A[B[i]] may be stored into the RT 240 when the producer executes. Then, when the consumer PC executes, the address of the consumer with the predicted address stored in the RT 240 may be compared. The comparison result may be used to increase or decrease prefetch confidence in the relationship.

In one or more aspects, if there is a TLB miss, the sixth prefetch generation trace 254 may operate to send the missed prefetch operation and corresponding address information to the POB 260 for performing a replay process 362 to possibly replay the virtual address of the missed prefetch operation. The seventh prefetch generation trace 264 may operate to send the virtual address of the missed prefetch operation for replay back to the translation lookaside buffer based on the result of the replay process 362.

As noted, there can be security concerns for prefetchers. Also as noted, one proposal to alleviate such concerns is to reset the training of the prefetcher when a prefetch training reset event occurs. As seen in FIG. 2, the training logic 275 may receive or otherwise be triggered with the prefetch training reset event, which may be a change in the execution level and/or change in the context of operations performed by the core (e.g., core 102, 202). That is, depending on the execution level and/or the context in which the core is currently operating in, it may be determined—e.g., by the training logic 275—whether to actually perform the prefetch training or not. For example, when the core is currently operating in a non-privileged execution level (more on this below), it may be decided that the prefetch training will take place. Alternatively, when the core is currently operating in a privileged execution level (also more on this below), it may be decided that the prefetch training will not take place.

Also, to make the process more efficient, when the prefetch training does take place (e.g., when the current execution level is the non-privileged execution level), the prefetch training information may be stored. For example, the training logic 275 may store the prefetch training information in a training info storage 280. Then the next time the processing core execution level returns (e.g., to the non-privileged execution level), then instead of performing the prefetch training anew, the prefetch training information stored in the training info storage 280 may be reused.

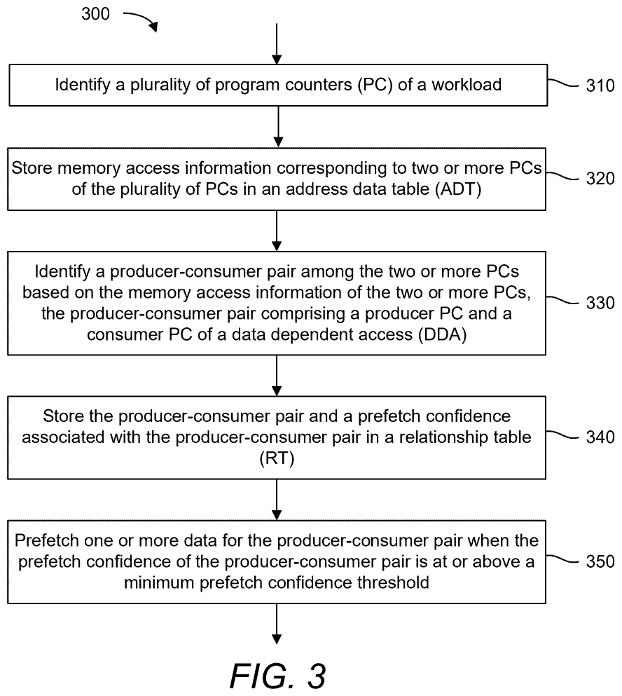

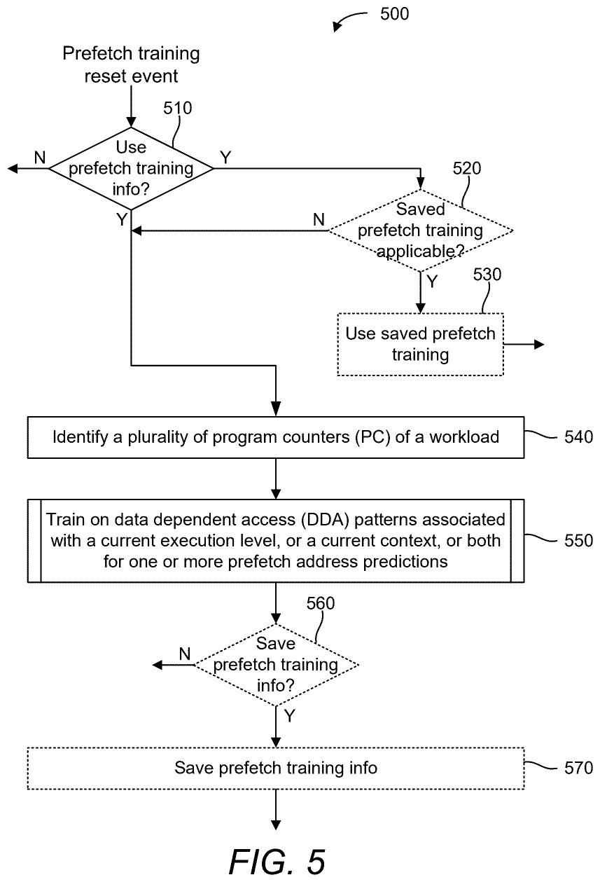

FIG. 3 illustrates a flow chart of a method 300 of prefetching (e.g., as performed by a prefetcher 200) in accordance with one or more aspects of the disclosure. The process for security maintenance will be discussed in relation to FIG. 5.

In block 310 of FIG. 3, the stride prefetcher 212 may identify a plurality of program counters (PC) of a workload.

In block 320, the ADT 230 may store memory access information corresponding to two or more PCs of the plurality of PCs. For a PC of the plurality of PCs in the ADT 230, the memory access information may comprise a PC identifier, a first address, a first data, a second address, and a second data. The PC identifier may be an identifier of the PC, the first address may be an address of a first load instruction of the PC, the first data may be a data corresponding to the first load instruction of the PC, the second address may be an address of a second load instruction of the PC subsequent to the first load instruction of the PC, and the second data may be a data corresponding to the second load instruction of the PC. The first address and first data may be an address and data of the PC when the first load instruction is committed and the second address and second data may be an address and data of the PC when the second load instruction is committed.

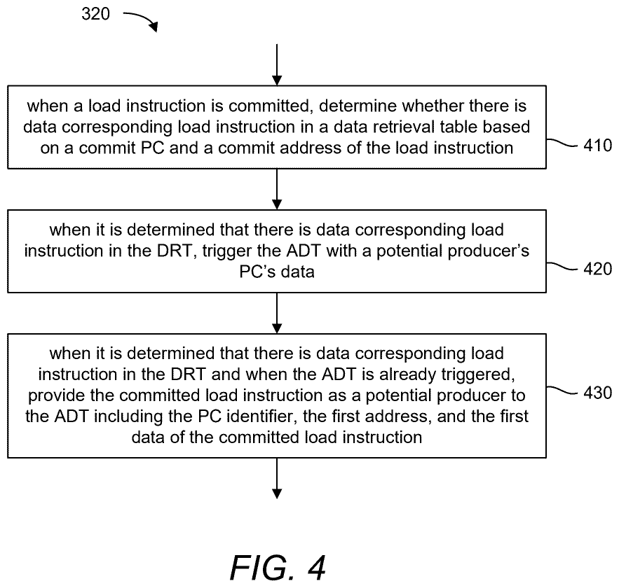

FIG. 4 illustrates an example process to implement block 320. Recall that the prefetcher 200 includes the DRT 220 configured to store data of one or more load instructions that have not yet been committed. In block 410, when a load instruction is committed, the DRT 220 may determine whether there is data corresponding to the committed load instruction in the DRT 220 based on a commit PC and a commit address of the load instruction.

When the DRT 220 determines that there is data corresponding to the load instruction in the DRT 220, then in block 420, the ADT 230 may be triggered with a potential producer's PC's data.

When the DRT 220 determines that there is no data corresponding to the load instruction in the DRT 220 and the ADT 230 is already triggered, then in block 430, the ADT 230 may receive the committed load instruction as a potential producer including the PC identifier, the first address, and the first data of the committed load instruction.

Referring back to FIG. 3, in block 330, the ADT 230 may identify a producer-consumer pair among the two or more PCs based on the memory access information of the two or more PCs. As noted, the producer-consumer pair may comprise a producer PC and a consumer PC of a data dependent access (DDA).

In block 340, the RT 240 may store the producer-consumer pair and a prefetch confidence associated with the producer-consumer pair.

Although FIGS. 3 and 4 show example blocks of the method 300, in some implementations, method 300 may include additional blocks, fewer blocks, different blocks, or differently arranged blocks than those depicted in FIGS. 3 and 4. Additionally, or alternatively, two or more of the blocks of method 300 may be performed in parallel. In one or more example aspects, the functions described may be implemented in hardware, software, firmware, or any combination thereof.

As indicated above, data-dependent prefetchers can be compromised. Thus, maintaining security of prefetchers is an issue. To alleviate such security concerns, it is proposed to reset the training of the prefetcher 200 when a prefetch training reset event occurs. When the prefetcher 200 is training on the data dependent access (DDA) patterns for one or more prefetch address predictions, the training may be associated with a current a current execution level, or a current context, or both. In an aspect, training may be inclusive of blocks 320, 330, 340 of FIG. 3.

Referring back to FIG. 2, a prefetch training reset event may include an execution level (EL) change from the current execution level to a next execution level. Alternatively or in addition thereto, a prefetch training reset event may include a context switch from the current context to a next context. Note that a context switch can occur within an execution level. Thus, the prefetch training reset event may include a context switch within the current execution level. Resetting when there is the EL change can prevent cross-execution contamination. Resetting when there is the context switch can prevent cross-context contamination.

In an aspect, there may be a plurality of execution levels, and the current execution level may be one of the plurality of execution levels. Then the execution level change may be viewed as a change from the current execution level to the next execution level. The next execution level may also be one of the plurality of execution levels. The plurality of execution levels may include, among others, a non-privileged execution level and one or more privileged execution levels. The non-privileged execution level may be a user space execution level. Also, each privileged execution level may be a space level other than the user space level, e.g., an operating system (OS) execution level, a kernel execution level, a hypervisor execution level, etc.

The different execution levels may be analogized to the different protection rings of a hierarchical protection domain. In this domain, the non-privileged execution level may be analogous to ring 3 domain, and the privileged execution levels may be analogous to rings 0-ring 2. From another perspective, the non-privileged and privileged execution levels may be analogous to user space and kernel space, respectively.

Alternatively or in addition thereto, there may be a plurality of contexts, and the current context may be one of the plurality of contexts. Then the context change may be viewed as a change from the current context to the next context. The next context may also be one of the plurality of contexts. The plurality of contexts may include, among others, one or more address space IDs (ASIDs), or one or more virtual memory IDs (VMIDs), or both. A context switch may include a switch from a ASID to a VMID or vice versa. The context switch may also include a switch from one ASID to another ASID. The context switch may further include a switch from one VMID to another VMID. As indicated above, the context switch may occur within the same execution level

In an aspect, the training logic 275 may be configured to turn on the prefetch training on the DDA patterns for the one or more prefetch address predictions when the current execution level is the non-privileged execution level. In other words, the training may take place when the prefetcher 200 is currently operating at the user space execution level. A prefetch training reset event may take place (see FIG. 2) when an execution level change occurs, e.g., from a privileged execution level to a non-privileged execution level.

Alternatively or in addition thereto, the training logic 275 may be configured to turn on the prefetch training on the DDA patterns for the one or more prefetch address predictions when the context changes while the core is operating within an execution level. In particular, the prefetch training may be turned on when switching to a different context while the operating within the non-privileged execution level. A prefetch training reset event may take place (see FIG. 2) when a context change occurs, e.g., while in the non-privileged execution level.

In another aspect, the training logic 275 may be configured to turn off the training on the DDA patterns for the one or more prefetch address predictions when the current execution level is not the non-privileged execution level. In other words, the training may be halted when the prefetcher 200 is operating at any of the privileged execution levels. One reason for this is that system operations such as malloc, memcpy, etc. can compromise the DDA prefetcher. For example, system calls are in EL1 and user code is in EL0. In general, the system calls should not know about the user level relationship, since if they are compromised, secrets can be fetched. The protection afforded by the one or more aspects can be provided in both directions. If EL1 code is allowed to prefetch based on relationships controlled at EL0, then the user can use cache timing to infer data values belonging to EL1. On the other hand, if the training at the EL1 is used to prefetch at EL0, then EL0 can learn the relationship established at EL1. Both of these undesirable situations can be prevented in the one or more aspects. A prefetch training reset event may take place (see FIG. 2) when an execution level change occurs, e.g., from a non-privileged execution level to a privileged execution level.

Recall from above that to make the process more efficient, the prefetch training information may be retained for use later in the future. For example, when the prefetch training is turned off (e.g., due to a prefetch training reset event indicating execution level change from non-privileged to privileged execution levels), the training logic 275 may determine whether the prefetch training information gathered while the training was on (e.g., while operating in the non-privileged execution level) should be saved. If so, the training logic 275 may store the prefetch training information in the training info storage 280.

Then when the prefetch training reset event occurs (e.g., switching to non-privileged execution level or switching context while in the non-privileged execution level), then instead of proceeding directly to prefetch training, it may be determined whether the training information stored in the training info storage 280 can be reused. For example, the core's operation may have switched from non-privileged execution level (from which the prefetch information has been saved) to privileged execution level back to the non-privileged execution level. In this instance, when the operation comes back to the non-privileged execution level the second time, then instead of newly training, the prefetch training information stored in the training info storage 280 may be reused.

Thus, when there is the option of using the information in the training info storage 280, the prefetch process may be modified as follows. When prefetch training reset event occurs, the training logic 275 may determine whether prefetch training information will be used. For example, it may be determined whether DDA pattern will be used for prefetching. If so and if the information stored in the training info storage 280 is applicable to the current execution level and/or current context, then the stored information may be used. If so but the stored information is not applicable, then the prefetch training may take place. Finally, if it is determined that DDA access pattern will NOT be used (e.g., execution level switch to privileged execution level took place), then the information in the training info storage 280 need not be used and the prefetch training need not take place.

In summary, there can be DDA independence among the execution levels and/or among the contexts. That is, the training logic 275 may be configured such that the DDA pattern information gathered while training in a first execution level is not used for prefetch address predictions while in a second execution level different from the first execution level. It should be noted that the first and second execution levels may be included in the plurality of execution levels. In general, it may be said that different prefetch training information are maintained for different execution levels, and information corresponding to one execution level is independent of information corresponding to any other execution level.

Alternatively or in addition thereto, the training logic 275 may be configured such that the DDA pattern information gathered while training in a first context is not used for prefetch address predictions while in a second context different from the first context. It should be noted that the first and second contexts may be included in the plurality of contexts. Again, in general, it may be said that different prefetch training information may be maintained for different contexts and information corresponding to one context is independent of information corresponding to any other context.

Recall from above that the training may take place when the prefetcher 200 is in the non-privileged (e.g., user space) execution level. Then in an aspect, whether the training continues to take place when the context switch occurs may also depend on the current execution level of operations of the processing cores. That is, the training logic 275 may be configured to turn on training for the one or more prefetch address predictions after switching to the next context within the current execution level when the current execution level is the user space execution level. Otherwise, the training logic 275 may be configured to turn off training for the one or more prefetch address predictions after switching to the next context when the current execution level is not the user space execution level.

FIG. 5 illustrates a flow chart of an example method of prefetching, such as by the prefetcher 200, that incorporates security enhancement when training for data dependent access prefetch address prediction. Blocks 520, 530, 560, and 570 are dashed to indicate their relevance to situations in which prefetch training information may be retained. These blocks may be viewed as “optional” depending on whether prefetch training information will be retained or not.

In block 510, when prefetch training reset event (e.g., change in execution level and/or change in context) takes place, the training logic 275 (i.e., the PTH 210, the PCP stride fetcher 212, the DRT 220, the ADT 230, and the RT 240) may determine whether prefetch training information will be used. For example, it may be determined that the prefetch training information will be used if the prefetch training reset event is an execution level (EL) change from a previous execution level to a current execution level. In particular, it may be determined that the prefetch training information will be used if the switch is from a privileged execution level (previous execution level) to non-privileged level (current execution level). It may also be determined that the prefetch training information will be used if the prefetch training reset event is a context switch within an execution level (e.g., within non-privileged execution level). On the other hand, it may be determined that prefetch training information will not be used if the prefetch training reset event is a switch to privileged execution level or a context switch while in privileged execution level.

If it is determined that the prefetch training information will be used (one ‘Y’ branch from block 510), then in block 520, the training logic 275 may determine whether saved prefetch training information (e.g., saved in the training info storage 280) is applicable. For example, the saved prefetch training operation may be determined to be applicable if the saved prefetch training information pertains to the same execution level of the current core operation. Otherwise, the saved prefetch training operation may be determined to be not applicable if the saved prefetch training information does not pertain to the same execution level of the current core operation.

In an alternative, a context criteria may also be attached. That is, the saved prefetch training operation may be determined to be applicable if both the saved prefetch training information pertains to the same execution level of the current core operation and also pertains to the same context of the current core operation. Otherwise, the saved prefetch training operation may be determined to be not applicable if the saved prefetch training information does not pertain to the same execution level of the current core operation or if the context is different.

If it is determined that the saved prefetch training information is applicable (‘Y’ branch from block 520), then in block 530, prefetching may take place according to the saved prefetch training information.

Block 540 may be reached in at least the following ways. Block 540 may be reached when it is determined that the prefetch training information will be used (other ‘Y’ branch from block 510). Block 540 may also be reached when it is determined that the saved prefetch training information is not applicable (‘N’ branch from block 520). In block 540, the training logic 275, and in particular the stride prefetcher 212, may identify a plurality of program counters (PC) of a workload.

In block 550, the training logic 275 may train on the data dependent access (DDA) patterns associated with a current execution level, or a current context, or both for one or more prefetch address predictions. In an aspect, the training on the DDA patterns may comprise blocks 320, 330 and 340 of FIG. 3. While not specifically shown in FIG. 5, prefetching make take place based on the training.

In block 560, the training logic 275 may determine whether that the prefetch training information, which has been derived through training (e.g., while performing block 550) is to be saved, e.g., in the training info storage 280. For example, it may be determined that the prefetch training information will be saved if the current execution level is non-privileged execution level. On the other hand, it may be determined that the prefetch training information will not be saved if the current execution level is privileged execution level. Note that if the prefetch training information pertaining to the current operation is already saved in the training info storage 280, saving the information again would not be necessary.

If it is determined that the prefetch training information is to be saved (‘Y’ branch from block 560), then in block 570, the training logic 275 may store the derived prefetch training information, e.g., in the training info storage 280.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended. Furthermore, it is also intended that aspects of a clause can be included in any other independent clause, even if the clause is not directly dependent on the independent clause.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Aspects of the present disclosure are illustrated in the description and related drawings directed to specific embodiments. Alternate aspects or embodiments may be devised without departing from the scope of the teachings herein. Additionally, well-known elements of the illustrative embodiments herein may not be described in detail or may be omitted so as not to obscure the relevant details of the teachings in the present disclosure.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described herein can be configured to perform at least a portion of a method described herein.

In certain described example implementations, instances are identified where various component structures and portions of operations can be taken from known, conventional techniques, and then arranged in accordance with one or more exemplary embodiments. In such instances, internal details of the known, conventional component structures and/or portions of operations may be omitted to help avoid potential obfuscation of the concepts illustrated in the illustrative embodiments disclosed herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Various components as described herein may be implemented as application specific integrated circuits (ASICs), programmable gate arrays (e.g., FPGAs), firmware, hardware, software, or a combination thereof. Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to”, “instructions that when executed perform”, “computer instructions to” and/or other structural components configured to perform the described action.

Those of skill in the art further appreciate that the various illustrative logical blocks, components, agents, IPs, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, processors, controllers, components, agents, IPs, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Nothing stated or illustrated depicted in this application is intended to dedicate any component, action, feature, benefit, advantage, or equivalent to the public, regardless of whether the component, action, feature, benefit, advantage, or the equivalent is recited in the claims.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or one or more claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions and/or functionalities of the methods disclosed.

Furthermore, in some examples, an individual action can be subdivided into one or more sub-actions or contain one or more sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A prefetcher, comprising:
a training logic configured to determine whether prefetch training information will be used when a prefetch training reset event occurs, the prefetch training reset event being an execution level (EL) change from a previous execution level to a current execution level, or a context switch from a previous context to a current context within an execution level; and
a stride prefetcher configured to identify a plurality of program counters (PC) of a workload when it is determined that the prefetch training information will be used,
wherein the training logic is configured to train on data dependent access (DDA) patterns associated with a current execution level, or a current context, or both for one or more prefetch address predictions when it is determined that the prefetch training information will be used, the training logic comprising:
an address data table (ADT) configured to store memory access information corresponding to two or more PCs of the plurality of PCs, the ADT also being configured to identify a producer-consumer pair among the two or more PCs based on the memory access information of the two or more PCs, the producer-consumer pair comprising a producer PC and a consumer PC of a data dependent access (DDA); and
a relationship table (RT) configured to store the producer-consumer pair and a prefetch confidence associated with the producer-consumer pair.

2. The prefetcher of claim 1,
wherein for a PC of the plurality of PCs in the ADT, the memory access information comprises, a PC identifier, a first address, a first data, a second address, and a second data, the PC identifier being an identifier of the PC, the first address being an address of a first load instruction of the PC, the first data being a data corresponding to the first load instruction of the PC, the second address being an address of a second load instruction of the PC subsequent to the first load instruction of the PC, and the second data being a data corresponding to the second load instruction of the PC,
wherein for the PC in the ADT, the first address and first data are an address and data of the PC when the first load instruction is committed and the second address and second data are an address and data of the PC when the second load instruction is committed, and
wherein the first address and the second address of the PC in the ADT are virtual addresses.

3. The prefetcher of claim 1, wherein the previous and current execution levels are included in a plurality of execution levels, the plurality of execution levels comprising one or more non-privileged execution levels and one or more privileged execution levels.

4. The prefetcher of claim 3,
wherein the one or more non-privileged execution levels include a user space execution level, and
wherein the one or more privileged execution levels include an operating system (OS) execution level, a kernel execution level, and a hypervisor execution level.

5. The prefetcher of claim 3, wherein the training logic is configured to determine that the prefetch training information will be used when the prefetch training reset event is a switch to one of the non-privileged execution levels.

6. The prefetcher of claim 3, wherein the training logic is configured to determine that the prefetch training information will not be used when the prefetch training reset event is a switch to one of the privileged execution levels.

7. The prefetcher of claim 3, wherein the training logic is configured such that the DDA pattern information gathered while training in a first execution level is not used for prefetch address predictions while in a second execution level different from the first execution level, the first and second execution levels being included in the plurality of execution levels.

8. The prefetcher of claim 1, wherein the previous and current contexts are included in a plurality of contexts, the plurality of contexts comprising one or more address space IDs (ASIDs), or one or more virtual memory IDs (VMIDs), or both.

9. The prefetcher of claim 8, wherein the training logic is configured to determine that the prefetch training information will be used when the prefetch training reset event is the context switch while the execution level is a non-privileged execution level.

10. The prefetcher of claim 8, wherein the training logic is configured to determine that the prefetch training information will not be used when the prefetch training reset event is the context switch while the execution level is a privileged execution level.

11. The prefetcher of claim 8, wherein the training logic is configured such that the DDA pattern information gathered while training in a first context is not used for prefetch address predictions while in a second context different from the first context, the first and second contexts being included in the plurality of contexts.

12. The prefetcher of claim 1, wherein when it is determined that prefetch training information will be used, the training logic is configured to:
prior to training on the DDA patterns, determine whether a saved prefetch training information is applicable;
use the prefetch training information stored in a training info storage for prefetching when it is determined that the saved prefetch training information is applicable; and
proceed to training on the DDA patterns when it is determined that the saved prefetch training information is not applicable.

13. The prefetcher of claim 12, wherein the training logic is configured to determine that the saved prefetch training information is applicable when the saved prefetch training information pertains to the current execution level.

14. The prefetcher of claim 12, wherein when it is determined that prefetch training information will not be used, the training logic is configured to, subsequent training on the DDA patterns, save prefetch training information gathered through training on the DDA patterns into the training info storage.

15. A method of prefetching, the method comprising:
determining whether prefetch training information will be used when a prefetch training reset event occurs, the prefetch training reset event being an execution level (EL) change from a previous execution level to a current execution level, or a context switch from a previous context to a current context within an execution level; and
identifying a plurality of program counters (PC) of a workload; and
training on data dependent access (DDA) patterns associated with a current execution level, or a current context, or both for one or more prefetch address predictions,
wherein training on the DDA patterns comprises:
storing store memory access information corresponding to two or more PCs of the plurality of PCs in an address data table (ADT);
identifying a producer-consumer pair among the two or more PCs based on the memory access information of the two or more PCs, the producer-consumer pair comprising a producer PC and a consumer PC of a data dependent access (DDA); and
storing the producer-consumer pair and a prefetch confidence associated with the producer-consumer pair in a relationship table (RT).

16. The method of claim 15,
wherein for a PC of the plurality of PCs in the ADT, the memory access information comprises, a PC identifier, a first address, a first data, a second address, and a second data, the PC identifier being an identifier of the PC, the first address being an address of a first load instruction of the PC, the first data being a data corresponding to the first load instruction of the PC, the second address being an address of a second load instruction of the PC subsequent to the first load instruction of the PC, and the second data being a data corresponding to the second load instruction of the PC,
wherein for the PC in the ADT, the first address and first data are an address and data of the PC when the first load instruction is committed and the second address and second data are an address and data of the PC when the second load instruction is committed, and
wherein the first address and the second address of the PC in the ADT are virtual addresses.

17. The method of claim 15,
wherein the previous and current execution levels are included in a plurality of execution levels, the plurality of execution levels comprising one or more non-privileged execution levels and one or more privileged execution levels,
wherein determining whether the prefetch training information will be used comprises determining that the prefetch training information will be used when the prefetch training reset event is a switch to one of the non-privileged execution levels.

18. The method of claim 15, wherein the previous and current contexts are included in a plurality of contexts, the plurality of contexts comprising one or more address space IDs (ASIDs), or one or more virtual memory IDs (VMIDs), or both.

19. The prefetcher of claim 1, wherein when it is determined that prefetch training information will be used, the training logic is configured to:
prior to training on the DDA patterns, determining whether a saved prefetch training information is applicable, the saved prefetch training information being stored in a training info storage;
using the prefetch training information stored in the training info storage for prefetching when it is determined that the saved prefetch training information is applicable; and
proceeding to training on the DDA patterns when it is determined that the saved prefetch training information is not applicable.

20. The method of claim 19, further comprising:
when it is determined that prefetch training information will not be used, subsequent training on the DDA patterns, saving prefetch training information gathered through training on the DDA patterns into the training info storage.
